(19) United States
(12) Patent Application Publication
(10) Pub. No.: US 2019/0315570 A1
(43) Pub. Date: Oct. 17, 2019

(54) DYNAMIC CONVEYOR BELT ITEM ALIGNMENT SYSTEM

(71) Applicant: Walmart Apollo, LLC, Bentonville, AR (US)

(72) Inventors: Behzad Nemati, Springdale, AR (US); Kyle Mchan, Fayetteville, AR (US); Arnabh Bhaumik, Bentonville, AR (US); Deepti Bisht, Bentonville, AR (US)

(21) Appl. No.: 16/383,501

(22) Filed: Apr. 12, 2019

Related U.S. Application Data
(60) Provisional application No. 62/658,959, filed on Apr. 17, 2018.

(51) Int. Cl. B65G 43/00; B65G 47/28

(52) U.S. Cl. CPC B65G 43/00; B65G 2203/0233; B65G 2203/041; B65G 47/28

(57) ABSTRACT

Examples provide a conveyor device for aligning items on a conveyor belt. An arm controller device activates extension and/or retraction of one or more item alignment arms across a width of a conveyor belt in accordance with a set of instructions to block or un-block items from moving down the conveyor belt. An item alignment controller analyzes the sensor data and item data using item recognition analytics and location detection analytics to generate location data for items on the conveyor belt. A selected item closest to a scan area is selected. A set of instructions, including a sequence, timing and/or degree of extension for each telescoping arm in the plurality of item alignment arms is generated. The instructions control the extension of the item alignment arms to stop the set of remaining items while permitting the selected item to move unobstructed down the conveyor belt.

### BACKGROUND

When customers purchase items at a checkout, the items are typically picked up one by one and manually scanned by a hand-held scanner device or a scanner device mounted on a counter or other fixture. Where multiple items are being scanned, those items may be piled up on the counter or on a conveyor belt until the clerk or customer manually scans each item one by one. This is frequently a slow and time-consuming process for both customers and cashiers.

### SUMMARY

Some examples provide a system for dynamic alignment of items on a conveyor belt. A conveyor device includes a conveyor belt and a set of side members running horizontally along each longitudinal side of the conveyor belt. The set of side members includes item alignment arms. The item alignment arms include a first set of telescoping arms attached to a first side member in the set of side members parallel to the conveyor belt and a second set of telescoping arms attached to a second side member in the set of side members opposite to the first side member. Each arm has a fully extended length equal to a width of the conveyor belt. Sensor devices generating sensor data associated with a plurality of items placed on the conveyor belt at a source location associated with a first end of the conveyor belt. A computing device includes a processor and a memory communicatively coupled to the memory. An item alignment controller implemented on the at least one processor analyzes the sensor data and item data using item recognition analytics and location detection analytics to generate location data and orientation data for each item in the plurality of items relative to the plurality of item alignment arms and an item scan location associated with a second end of the conveyor belt. The item alignment controller identifies a selected item for scanning and a set of remaining items from the plurality of items based on the location and orientation data. The item alignment controller generates a set of instructions. The set of instructions include a sequence, timing and degree of extension for each telescoping arm to stop the set of remaining items while permitting the selected item to move unobstructed along the conveyor belt to the item scan area. An arm controller device dynamically activates at least partial extension of at least one telescoping arm across the width of the conveyor belt in accordance with the set of instructions.

Other examples provide a computer-implemented method for dynamically aligning items on a conveyor belt. A communications interface component obtains sensor data generated by sensor devices associated with items on a moving conveyor belt via a network. An analysis component analyzes the sensor data and item data associated with the items using item recognition analytics and location detection analytics to generate location data and orientation data for each item on the conveyor belt. An item selection component identifies a first selected item and a set of remaining items on the conveyor belt based on the location data and orientation data. A dynamic instruction generator component generates a set of instructions. The set of instructions includes a degree of extension for each telescoping arm associated with the conveyor belt. The instructions control extension of the telescoping arms to stop the set of remaining items from proceeding down the conveyor belt while permitting the selected item to proceed into an item scan area at a second end of the conveyor belt. An arm controller device dynamically activates at least partial extension of at least one of the telescoping arms to extend at least partially across the width of the conveyor belt in accordance with the set of instructions.

Still other examples provide a conveyor device for aligning items on a conveyor belt. The conveyor device includes a conveyor belt configured to move a plurality of items from a source location at a first end of the conveyor belt to a scan location at a second end of the conveyor belt. A first side member runs horizontally along a first longitudinal side of the conveyor belt. A second side member runs horizontally along a second longitudinal side of the conveyor belt opposite to the first longitudinal side. An arm controller device controls extensions and retraction of item alignment arms. The item alignment arms include a first set of telescoping arms associated with the first side member and a second set of telescoping arms associated with the second side member. Each telescoping arm has a length equal to the width of the conveyor belt. The first set of telescoping arms includes a first telescoping arm located a first distance from a second telescoping arm. The second set of telescoping arms includes a third arm and a fourth arm located a second distance away from the third arm. A communications interface component receives a set of instructions from an item alignment controller via a network. The arm controller device dynamically activates at least partial extension of at least one telescoping arm arms across the width of the conveyor belt in accordance with the set of instructions to permit a selected item in the plurality of items to move along the conveyor belt towards the item scan location while stopping a set of remaining items from proceeding down the conveyor belt until the selected item reaches the item scan location.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for aligning items on a conveyor belt.

FIG. 2 is an exemplary block diagram illustrating a conveyor device.

FIG. 3 is an exemplary block diagram illustrating a conveyor device including a plurality of telescoping arms.

FIG. 4 is an exemplary block diagram illustrating a plurality of telescoping arms.

FIG. 5 is an exemplary block diagram illustrating a set of telescoping arms.

FIG. 6 is an exemplary block diagram illustrating a telescoping arm.

FIG. 7 is an exemplary block diagram illustrating a side member of a conveyor device.

FIG. 8 is an exemplary block diagram illustrating a cross-section view of a fully extended telescoping arm.

FIG. 9 is an exemplary block diagram illustrating a cross-section view of a partially extended telescoping arm.

FIG. 10 is an exemplary block diagram illustrating a side member including a set of arm housings.

FIG. 11 is an exemplary block diagram illustrating a set of sensor devices.

FIG. 12 is an exemplary block diagram illustrating an item alignment controller.

FIG. 13 is an exemplary block diagram illustrating a top view of a conveyor device with a set of partially extended telescoping arms.

FIG. 14 is an exemplary block diagram illustrating a top view of a conveyor device including a set of sensor devices.

FIG. 15 is an exemplary block diagram illustrating a top view of a conveyor device including a single extended telescoping arm.

FIG. 16 is an exemplary block diagram illustrating a top view of a conveyor device including a partially extended arm and a fully extended arm.

FIG. 17 is an exemplary block diagram illustrating a top view of a conveyor device including three extended telescoping arms.

FIG. 18 is an exemplary block diagram illustrating extension of an item alignment arm as items move down a conveyor belt.

FIG. 19 is an exemplary block diagram illustrating extension of item alignment arms associated with a conveyor device.

FIG. 20 is an exemplary block diagram illustrating partial extension of a plurality of arms to stop a set of remaining items on a moving conveyor belt.

FIG. 21 is an exemplary flow chart illustrating operation of the computing device to transmit real-time instructions to an arm controller device.

FIG. 22 is an exemplary flow chart illustrating operation of the computing device to activate extension of a set of arms to stop a set of remaining items from moving down a conveyor belt.

FIG. 23 is an exemplary flow chart illustrating operation of the computing device to generate instructions for retracting a set of arms to permit a selected item to move to a scan area.

Corresponding reference characters indicate corresponding parts throughout the drawings.

### DETAILED DESCRIPTION

Referring to the figures, examples of the disclosure enable a conveyor belt system for aligning items on a moving conveyor belt. In some examples, the conveyor belt system includes a set of four item alignment arms that extend across a moving conveyor belt in a sequence to permit a selected item to enter a scan zone at the end of the convey belt while preventing one or more remaining items from entering the scan zone. This permits the system to align items on the conveyor belts such that only a single item enters the scan zone at a time. This enables more efficient, automated scanning of items via an automated conveyor belt and scanning system without human intervention. The conveyor belt system further improves the speed and accuracy of automated item scanning/processing via a self-checkout.

In some examples, the item alignment arms are telescoping arms having two or more segments in which one segment is configured to nest inside another segment. The compressed/retracted arms are compactly stored within arm housings within side members of the conveyor belt. The telescoping arms extend to various length based on the number of segments engaged/extended. This enables the system to easily and efficiently extend and retract the item alignment arms while minimizing the amount of space required to house the arms when they are not being used to block items on the conveyor belt.

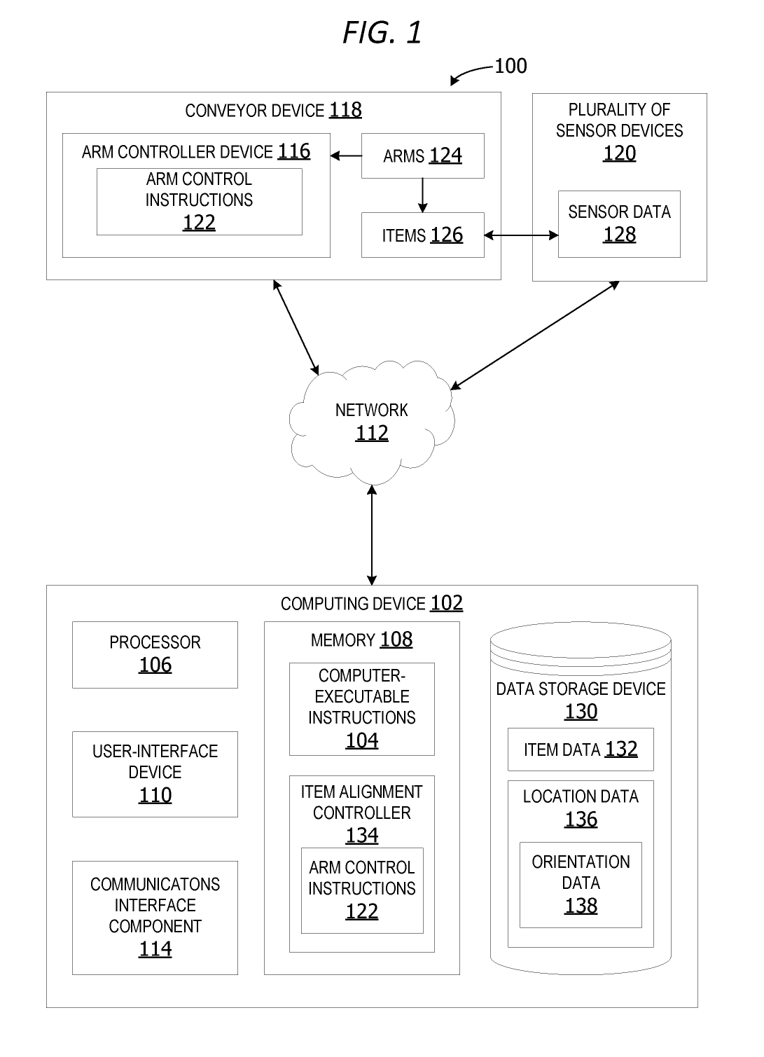

Referring again to FIG. 1, an exemplary block diagram illustrates a system 100 for aligning items on a conveyor belt. In the example of FIG. 1, the computing device 102 represents any device executing computer-executable instructions 104 (e.g., as application programs, operating system functionality, or both) to implement the operations and functionality associated with the computing device 102. The computing device 102 can include a mobile computing device or any other portable device. In some examples, the mobile computing device includes a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102 can also include a user interface component 110.

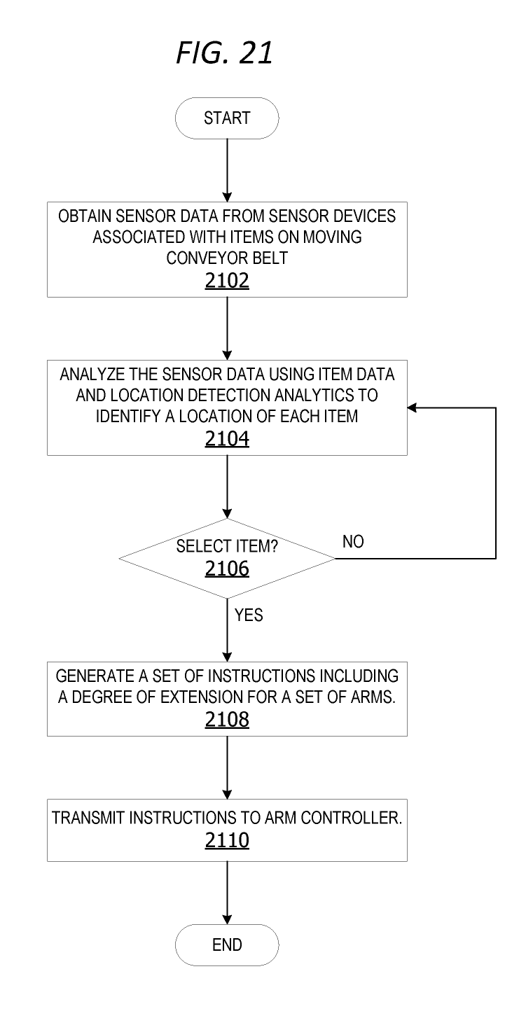

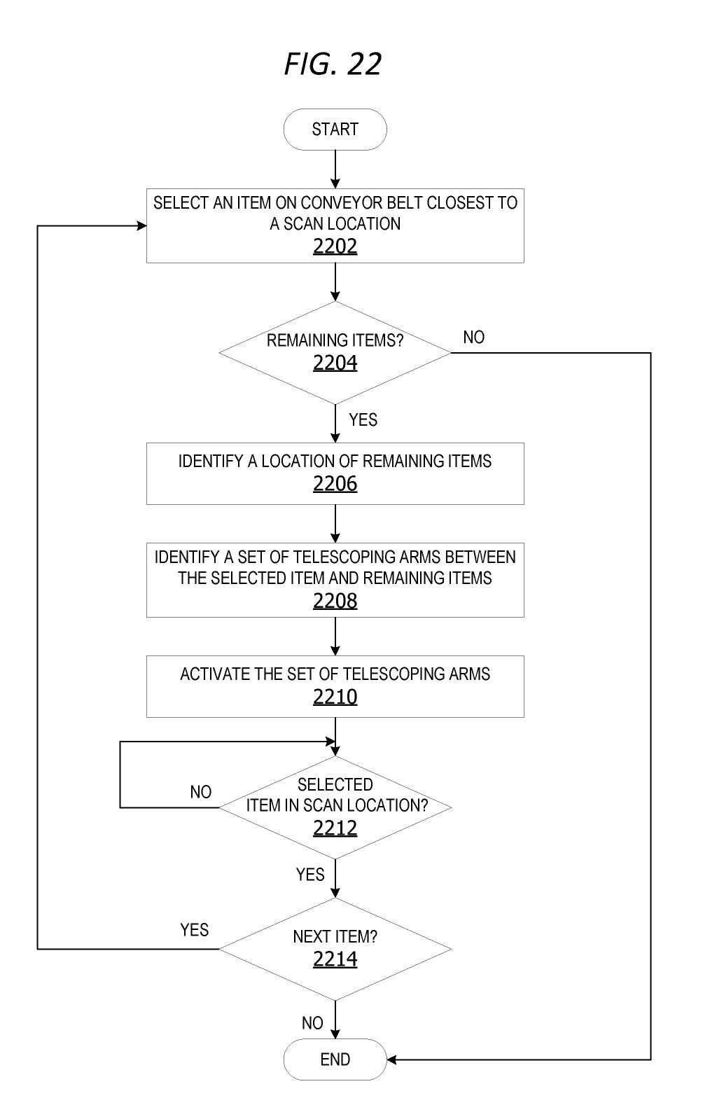

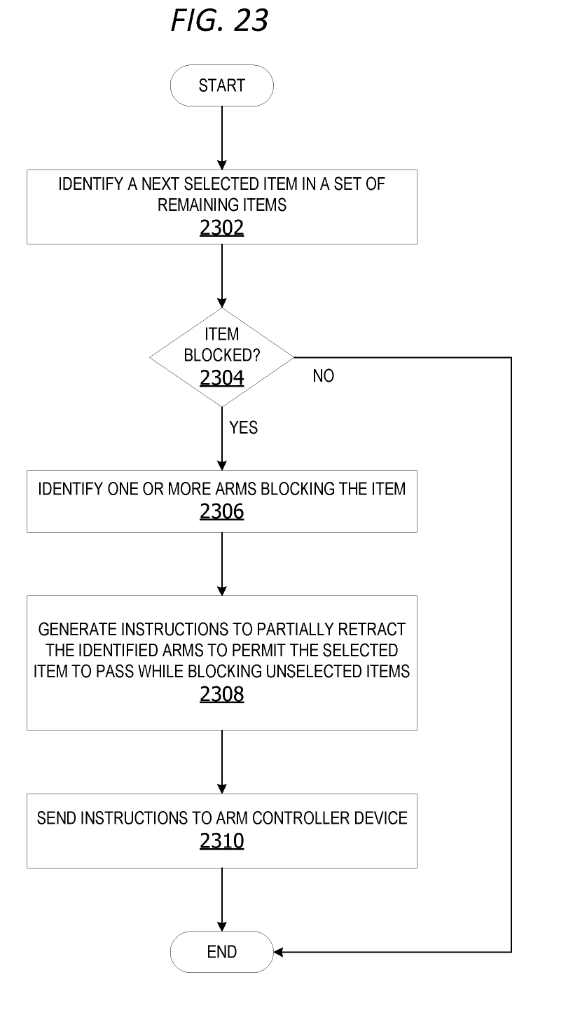

The processor 106 includes any quantity of processing units and is programmed to execute the computer-executable instructions 104. The computer-executable instructions 104 can be performed by the processor 106 or by multiple processors within the computing device 102 or performed by a processor external to the computing device 102. In some examples, the processor 106 is programmed to execute instructions such as those illustrated in the figures (e.g., FIG. 21, FIG. 22 and FIG. 23).

The computing device 102 further has one or more computer-readable media such as the memory 108. The memory 108 includes any quantity of media associated with or accessible by the computing device 102. The memory 108 can be internal to the computing device 102 (as shown in FIG. 1), external to the computing device (not shown), or both (not shown). In some examples, the memory 108 includes read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. For example, the applications can represent downloaded client-side applications that correspond to server-side services executing in a cloud.

In other examples, the user interface component 110 includes a graphics card for displaying data to the user and receiving data from the user. The user interface component 110 can also include computer-executable instructions (e.g., a driver) for operating the graphics card. Further, the user interface component 110 can include a display (e.g., a touch screen display or natural user interface) and/or computer-executable instructions (e.g., a driver) for operating the display. The user interface component 110 can also include one or more of the following to provide data to the user or receive data from the user: speakers, a sound card, a camera, a microphone, a vibration motor, one or more accelerometers, a BLUETOOTH® brand communication module, global positioning system (GPS) hardware, and a photoreceptive light sensor. In a non-limiting example, the user inputs commands or manipulate data by moving the computing device 102 in one or more ways.

The network 112 is implemented by one or more physical network components, such as, but without limitation, routers, switches, network interface cards (NICs), and other network devices. The network 112 can be any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface device 114. The communications interface device 114 includes a network interface card and/or computer-executable instructions (e.g., a driver) for operating the network interface card. Communication between the computing device 102 and other devices, such as but not limited to the arm controller device 116 on the conveyor device 118 and/or a plurality of sensor devices 120, can occur using any protocol or mechanism over any wired or wireless connection. In some examples, the communications interface device 114 is operable with short range communication technologies such as by using near-field communication (NFC) tags.

The arm controller device 116 utilizes arm control instructions 122 received from the computing device 102 via the network 112 to control the extension and/or retraction of one or more item alignment arm(s) 124. The item alignment arm(s) 124 are extended and retracted to align items 126 on a moving conveyor belt as the items move towards a scanning area. In some examples, the conveyor device 118 aligns the items 126 in single file formation. The device only permits a single item to pass into the scan zone at a time.

The plurality of sensor devices 120 generate sensor data 128 associated with one or more of the items 126 in real-time as the items 126 move down the conveyor belt. The sensor data 128 can include image capture data generating by one or more image capture devices, such as, but not limited to, images of the items.

The system 100 can optionally include a data storage device 130 for storing data, such as, but not limited to item data 132. The item data 132 can include a description of an appearance of each of the items 126. For example, the item data 132 can include data associated with a size, shape, color, labeling, barcode data, unit size, weight, or other data describing an item.

The data storage device 130 can include one or more different types of data storage devices, such as, for example, one or more rotating disks drives, one or more solid state drives (SSDs), and/or any other type of data storage device. The data storage device 130 in some non-limiting examples includes a redundant array of independent disks (RAID) array. In other examples, the data storage device 130 includes a database.

The data storage device 130 in this example is included within the computing device 102 or associated with the computing device 102. In other examples, the data storage device 130 is a remote data storage accessed by the computing device via the network 112, such as a remote data storage device, a data storage in a remote data center, or a cloud storage.

The memory 108 in some examples stores one or more computer-executable components. Exemplary components include an item alignment controller 134. The item alignment controller 134, when executed by the processor 106 of the computing device 102, obtains the sensor data 128 from the plurality of sensor devices 120 via the network 112. The item alignment controller 134 analyzes the sensor data 128 and the item data 132 using item recognition analytics and/or location detection analytics. The item alignment controller 134, generates location data 136, including orientation data 138, for each item on the conveyor belt. The location data 136 includes data describing a location of each item on the conveyor belt relative to each of the arm(s) 124, the source location where items are placed on the conveyor belt at the beginning of the conveyor belt and/or the scan location ate the end of the conveyor belt. The item alignment controller 134, selects an item and one or more remaining items on the conveyor belt based on the location data 136, including the orientation data 138.

In some examples, the item alignment controller 134 generates the arm control instructions 122 specifying a degree of extension for each of the arm(s) 124 to stop the one or more remaining items from proceeding down the conveyor belt to the item scan area while permitting the selected item to move unobstructed toward the item scan area.

In some examples, an arm controller device 116 dynamically controls (activates) extension and/or retraction of the arm(s) 124. A robotic arm, in some examples, partially extends across a portion of the conveyor belt or fully extends all the way across the entire width of the conveyor belt. The robotic arm can fully retract into the arm housing or only partially retract such that a portion of the robotic arm extends across a portion of the width of the conveyor belt while another portion is retracted into the housing.

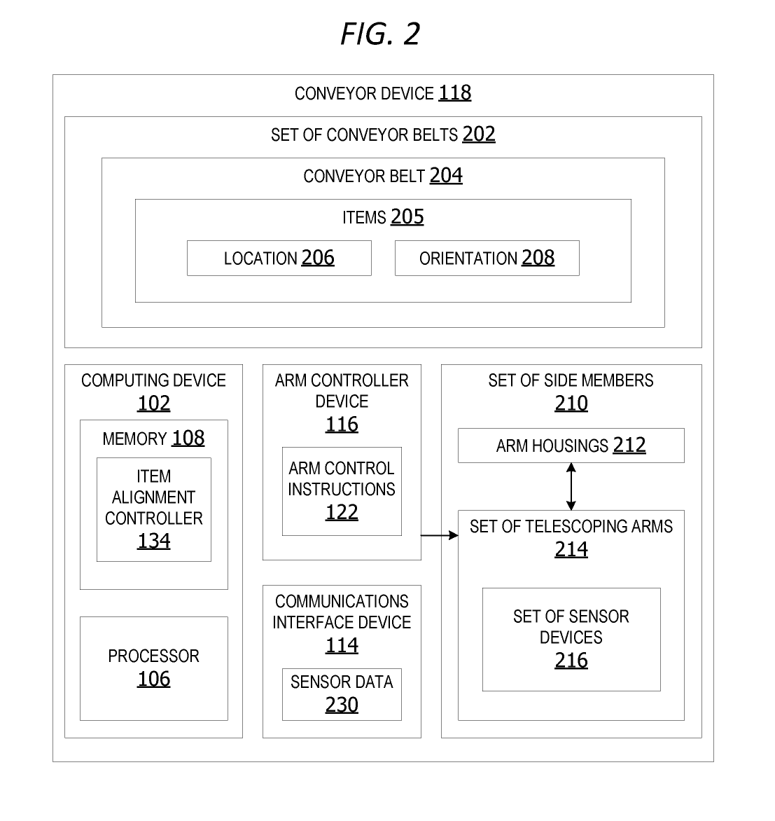

FIG. 2 is an exemplary block diagram illustrating a conveyor device 200. The conveyor device 118 includes a set of one or more conveyor belts, such as a conveyor belt 202, associated with a checkout station at a retail location, such as a store. The store can include, for example but without limitation, a grocery department, a hardware/tool department, a garden center, an automotive center, pet supplies, office supplies, or any other type of store.

A conveyor belt 204 in the set of conveyor belts 202 includes one or more items 205. In this non-limiting example, the items 205 are placed on the conveyor belt 204 in a single layer (un-stacked) configuration. The items can be placed side-by-side and/or one in front of the other. However, items are not stacked on top of each other.

Each item has a location 206 on the conveyor belt and an orientation 208. The location 206 refers to the location of the item on the conveyor belt. The location 206 can refer to the position of the item relative to a source location at the first end of the conveyor belt and/or a scan area at the second end of the conveyor belt. The source location is the location at the beginning of the conveyor belt where items are placed onto the conveyor belt. The scan area is located at the terminal end of the conveyor belt 204 where items are scanned for checkout. The orientation 208 refers to whether the item is sifting on the conveyor belt in an upright orientation, sideways, upside down, etc.

A set of side members 210 includes two side members running along each side of the conveyor belt 204. Each side member in the set of side members 210 forms a lip, barrier, or side-wall to prevent items from falling off the sides of the conveyor belt 204. Each side member includes one or more arm housing(s) 212. Each arm housing is a recess, pocket, cavity, or encasement for enclosing a collapsed telescoping arm or a base portion of a partially extended or fully extended telescoping arm in a set of telescoping arms 214.

The set of telescoping arms includes one or more telescoping arms connected to at least a portion of an inner surface of at least one side member in the set of side members 210. In some non-limiting examples, the set of telescoping arms 214 includes four arms. In other examples, the set of telescoping arms 214 includes three arms. In still other examples, the set of telescoping arms 214 includes five arms.

An arm controller device 116 activates one or more of the telescoping arms in the set of telescoping arms 214 to extend or retract in accordance with dynamic arm control instructions 122 received in real-time as the items 205 are moving down the conveyor belt 204. The arm controller device 116 is connected to each arm in the set of telescoping arms 214 via a set of wired connections (not shown).

In some non-limiting examples, the arm controller device 116 includes a computing device 102. The computing device 102 includes a processor 106 and a memory 226. The item alignment controller 134 component executing on the memory 226 analyzes sensor data 230 received from one or more sensor devices via the communications interface device 110 to determine the location 206 of each item on the conveyor belt 204. The item alignment controller 134 generates the arm control instructions 122 for activating the set of telescoping arms 214 in real-time to properly align the items 205 for scanning one at a time.

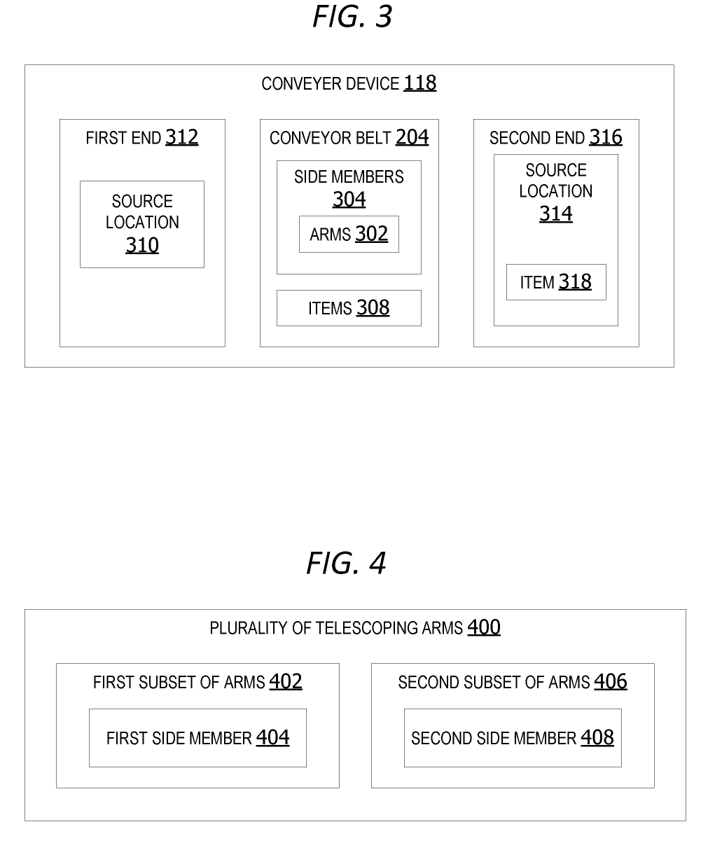

FIG. 3 is an exemplary block diagram illustrating a conveyor device 118 including one or more telescoping arms 302. Each telescoping arm is attached to one or more side members 304 associated with a conveyor belt 204. The side members 304 include one or more side members, such as, but not limited to, a side member in the set of side members 210 in FIG. 2.

Two or more items 308 are placed onto the conveyor belt 204 at a source location 310 associated with a first end 312 of the conveyor belt 204. The conveyor belt 204 moves the items 308 towards a scan location 314 associated with a second (terminal) end 316 of the conveyor belt 204.

The conveyor device 118 permits a single selected item 318 to move down the conveyor belt 204 to the scan location 314. The conveyor device 118 activates extension and retraction of the one or more of the arms 302 to stop/prevent one or more remaining items from reaching the scan location 314 until the selected item 318 has reached the scan location 314. Once the selected item 318 has reached the scan location 314, the conveyor device 118 identifies a next selected item from the remaining items on the conveyor belt 204. The conveyor device 118 activates extension and/or retraction of the one or more of the arms 302 to unblock the next selected item while continuing to block the remaining items on the conveyor belt, such that only one item at a time reaches the scan location 314.

FIG. 4 is an exemplary block diagram illustrating a plurality of telescoping arms 400. The plurality of telescoping arms 400 includes a first subset of arms 402 attached to a first side member 404 and a second subset of arms 406 attached to a second side member 408. The side member 404 and 408 are side members, such as, but not limited to, a side member in the set of side members 210 in FIG. 2.

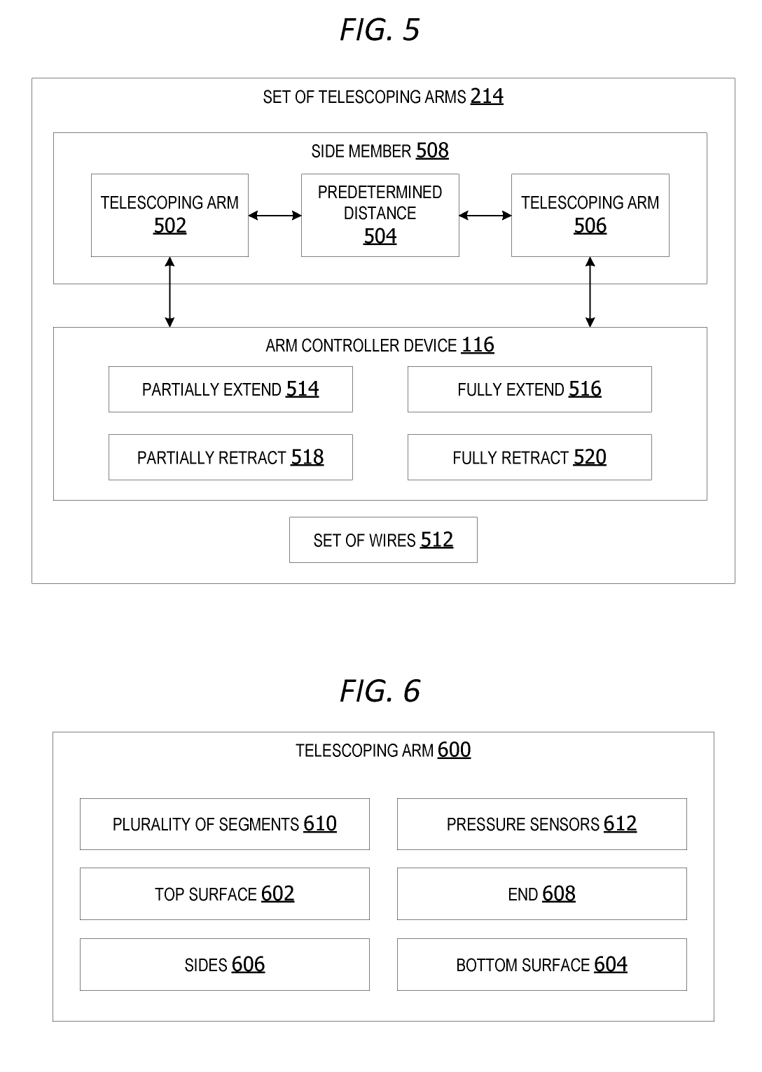

FIG. 5 is an exemplary block diagram illustrating a set of telescoping arms 214. The set of telescoping arms 214 includes a first telescoping arm 502 located a predetermined distance 504 from a second telescoping arm 506 attached to a side member 508 of a conveyor belt.

An arm controller device 116 is connected to the telescoping arm 502 and the telescoping arm 506 via a set of wires 512. The arm controller device 116 activates the telescoping arm 502 and the telescoping arm 506 to partially extend 514 one or more of the telescoping arms across a portion of the width of the conveyor belt or fully extend 516 one or more of the telescoping arms across the entire width of the conveyor belt.

In other examples, the arm controller device 116 activates the telescoping arm 502 and the telescoping arm 506 to partially retract 518 one or more of the telescoping arms into the arm housing(s), such that only a portion of the telescoping arm(s) are extended across a portion of the width of the conveyor belt and another portion of the telescoping arm(s) are retracted within the housing(s). The arm controller device 116 can also activate the telescoping arm(s) to fully retract 520 (completely collapse) into the arm housing(s). In the fully retracted state, there is no portion of the arm(s) extending across any portion of the conveyor belt.

FIG. 6 is an exemplary block diagram illustrating a telescoping arm 600. The telescoping arm 600 includes a top surface 602, a bottom surface 604, two sides 606 and an end 608. The telescoping arm 600 includes two or more telescoping segments, in which one segment collapses or retracts into another slightly larger segment. In other words, one segment of the telescoping arm 600 is capable of nesting inside another segment of the telescoping arm 600. In some examples, the telescoping arm 600 includes one or more pressure sensor(s) 612. The pressure sensor(s) 612 generate pressure sensor data associated with one or more items in contact with one of the sides 606 of the telescoping arm or the end 608 of the telescoping arm. The conveyor device 118 analyzes the pressure sensor data to identify the location of one or more objects on the conveyor belt.

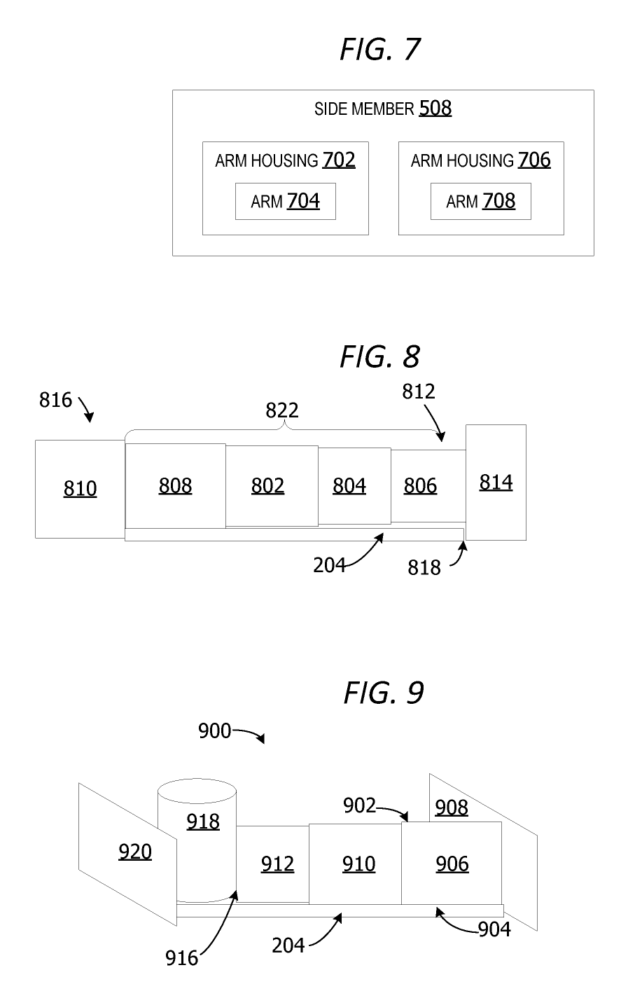

FIG. 7 is an exemplary block diagram illustrating a side member 508 of a conveyor device. The side member 508 includes a first arm housing for enclosing a first segmented and telescoping arm 704 and a second arm housing 706 enclosing a second segmented and telescoping arm 708. The arm housing 702 and the arm housing 706 is a cavity, recess or compartment sized to enclose a fully collapsed/nested arm, such as, but not limited to, the one or more arm housing(s) 212 in FIG. 2.

In this example, the side member 508 includes two arm housings enclosing two arms. In other examples, the side member 508 includes a single arm housing enclosing a single arm. In still other examples, the side member 508 includes three or more arm housings enclosing three or more telescoping arms.

FIG. 8 is an exemplary block diagram illustrating a cross-section view of a fully extended telescoping arm 800. The telescoping arm 800 includes a set of two or more segments. In this example, the segments include segment 802, segment 804, segment 806, and segment 808. The segment 806 nests within segment 804 when the telescoping arm 800 is partially retracted. Likewise, segment 804 nests within segment 802 when the telescoping arm is completely retracted. An end of the last segment 808 connects to a housing member 810. All the segments retract/nest within the last segment 808 inside the arm housing 810. The arm housing is a housing, such as, but not limited to, the one or more arm housing(s) 212 in FIG. 2. The collapsed/nested telescoping arm 800 is enclosed within a recess formed by the arm housing 810 when the telescoping arm 800 is completely collapsed.

In some examples, when the telescoping arm 800 is completely extended to its greatest length, an end 812 of the telescoping arm 800 contacts a first side member 814 opposite to a second side member 816 associated with the arm housing 810. In other examples, the end 812 flush with an end 818 of a conveyor belt. In still other examples, when the telescoping arm 800 is fully extended, a length 822 of the telescoping arm is equal to a length of the conveyor belt 204.

FIG. 9 is an exemplary block diagram illustrating a cross-sectional view of a partially extended telescoping arm 900. The telescoping arm 900 includes a top surface 902 and a bottom surface 904 running parallel with a conveyor belt 204. A first segment 906 of the telescoping arm 900 is attached to an interior portion of an arm housing 908. The arm housing 908 is a housing, such as, but not limited to, the one or more arm housing(s) 212 in FIG. 2.

The telescoping arm 900 further includes second segment 910 and a third segment 912. However, the examples are not limited to a telescoping arm having three segments. In other examples, the telescoping arm 900 includes two segments in which a first segment collapses into a hollow interior portion of second slightly larger segment. In still other examples, the telescoping arm 900 is a device that includes four or more collapsible (nestable) segments.

In this non-limiting example, the telescoping arm 900 is partially extended across the conveyor belt 204. An end 916 of the telescoping arm 900 is in contact with an item 918. The telescoping arm 900 pushes an unselected item 918 in a set of remaining items against a side member 920 opposite to the arm housing. The side member 920 is a member, such as, but not limited to, the side member 508 in FIG. 5.

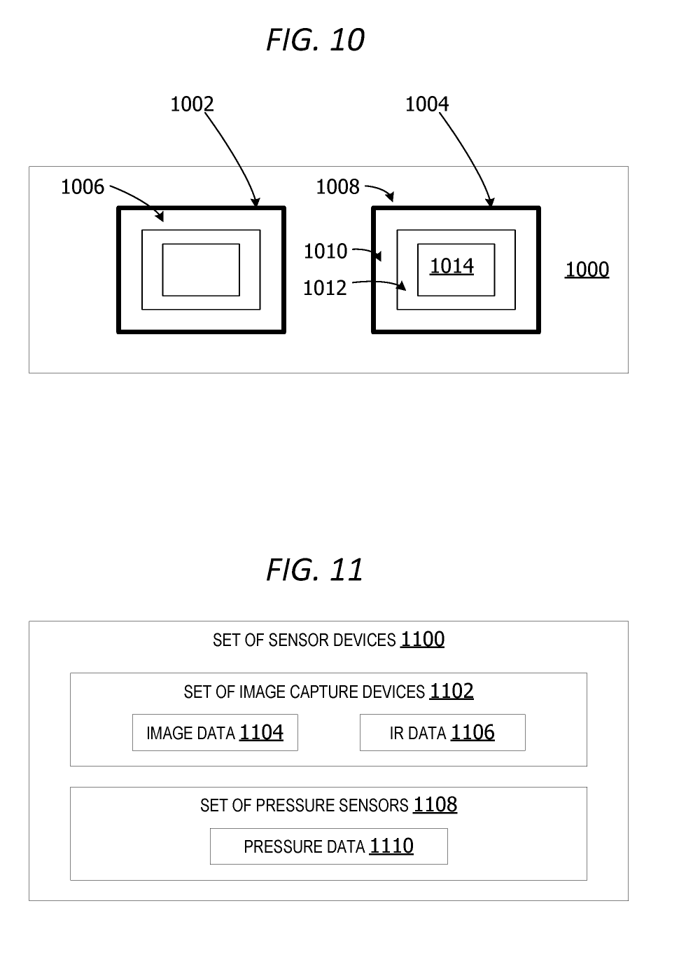

FIG. 10 is an exemplary block diagram illustrating a side member 1000 including a set of arm housings. In some examples, the arm housing includes a first arm housing 1002 and a second arm housing 1004, such as, but not limited to, the one or more arm housing(s) 212 in FIG. 2.

The first arm housing 1002 in this example encloses a retracted item alignment arm 1006. The second arm housing 1004 encloses a retracted item alignment arm 1008. The examples are not limited to two arms or two arm housings. In other examples, the side member 1000 includes a single arm housing enclosing a single arm. In other examples, the side member 1000 includes three or more arm housings enclosing three or more retracted arms.

In this non-limiting example, a first segment 1010 is collapsed/nested within the arm housing 1004. A second segment 1012 of the item alignment arm is collapsed/nested within the first segment 1010. The segments of the item alignment arm define an empty space 1014 at the center of the item alignment arm. In other words, the alignment arm 1008 is hollow.

When the arm 1008 is fully retracted, in some examples, the nested arms segments are substantially flush with the side member 1000. When the arm is partially retracted, in this example, one or more segments of the arm protrude perpendicularly with the side member 1000.

FIG. 11 is an exemplary block diagram illustrating a set of sensor devices 1100. The set of sensor devices 1100 can include a set of image capture devices 1102. The set of image capture devices 1102 can include one or more cameras as well as one or more infrared sensor devices. The set of image capture devices 1102 generates image data 1104 and/or IR data 1106 associated with one or more items.

The set of sensor devices 1100 optionally includes a set of one or more pressure sensors 1108. The set of pressure sensors 1108 generate pressure data 1110 associated with one or more items on the conveyor belt. A pressure sensor in the pressure sensors 1108 can include a sensor such as, but not limited to, the one or more pressure sensor(s) 612 in FIG. 6.

The set of sensor devices 1100 in some examples include one or more sensors positioned above the conveyor device, such as a sensor on a ceiling or chandelier hanging above the conveyor device. In other examples, the set of sensor devices 1100 includes one or more sensors positioned along the sides and/or ends of the conveyor device. In still other examples, the set of sensor devices includes one or more sensor devices embedded within one or more telescoping arms.

In one example, the set of sensor devices 1100 includes a pressure sensor embedded within a side of the telescoping arm that is perpendicular to the surface of the conveyor belt. In other examples, the set of sensor devices 1100 includes a pressure sensor embedded within an end of a telescoping arm.

In other non-limiting examples, the set of sensor devices 1100 optionally include proximity sensors, motion sensors, light sensors (photoreceptive), radio frequency identifier (RFID) tag readers, weight sensors, or any other type of sensor devices for generating sensor data. The sensor data is analyzed to identify the location of items on the conveyor belt in real-time as the items are being carried along by a moving conveyor belt.

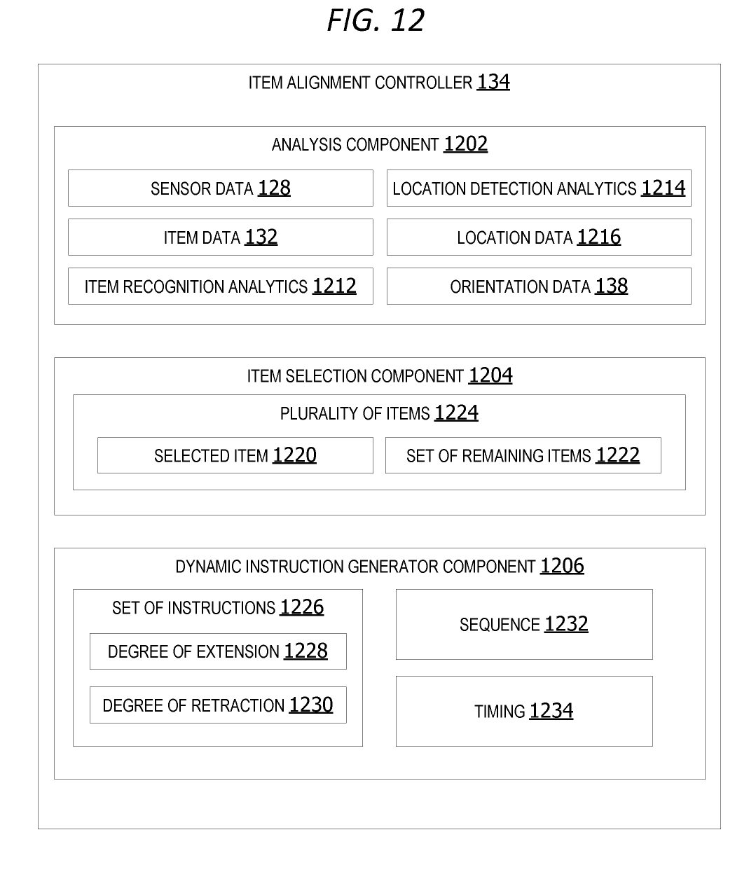

FIG. 12 is an exemplary block diagram illustrating an item alignment controller 134. The item alignment controller 134 in some examples includes an analysis component 1202, an item selection component 1204, and a dynamic instruction generator component 1206.

In some examples, the item alignment controller 134 obtains sensor data 128 from a set of sensor devices associated with items placed on a moving conveyor belt, such as, but not limited to, the set of sensor devices 1100 in FIG. 11. The analysis component 1202 analyzes the sensor data 128 and item data 132 using item recognition analytics 1212. The item recognition analytics 1212 include pattern recognition for analytics for identifying an item based on an image of the item. The analysis component 1202 can also include location detection analytics 1214 for analyzing the sensor data 128 and item data 132 to generate location data 136 and orientation data 138 for each of the items on the conveyor belt. The location data 136 in some examples identifies a location of each item relative to the item alignment arms and an item scan location associated with a second end of the conveyor belt.

The item selection component 1204 analyzes the location data 136 and the orientation data 138 to select an item for scanning. The selected item 1220 is the item on the conveyor belt that is located closest to the scan location and farthest from the source location. The item selection component 1204 also identifies a set of one or more remaining items 1222 from the plurality of items 1224 on the conveyor belt. The set of remaining items 1222 includes one or more un-selected items on the conveyor belt. The item alignment arms are extended or partially extended to create a barrier blocking the set of remaining items 1222 from moving past the item alignment arms.

In some examples, a dynamic instruction generator component 1206 determines which telescoping arms to extend, which telescoping arms to retract, which telescoping arms to remain retracted, and which telescoping arms to remain extended to stop the set of remaining items 1222 from moving with the conveyor belt towards to the scan location while permitting the selected item 1220 to move with the conveyor belt until it arrives at the scan location.

The dynamic instruction generator component 1206 in other examples generates a set of arm control instructions 1226, including a degree of extension 1228 and/or a degree of retraction 1230 for each arm in the set of telescoping arms associated with a conveyor device. The set of arm control instructions 1226 can include instructions, such as, but not limited to, the arm control instructions 122 in FIG. 1.

The degree of extension 1228 can indicate how many segments of a telescoping arm should be extended and/or indicate a length of extension. If a retracted arm is to remain retracted, the degree of extension can be zero (null value). The degree of retraction 1230 indicates how many segments of a telescoping arm should be retracted/collapsed. The degree of retraction 1230 can also indicate a final length of a partially retracted arm. If a fully extended arm or a partially extended arm is to remain the same without retracting any of its segments, the degree of retraction for that arm can be zero (null value).

The set of arm control instructions 1226 in other examples includes a sequence 1232 for extending or retracting multiple arms. For example, if there is a set of four arms, the sequence 1232 can indicate that the first arm closes to a source location and a fourth arm farthest from the source location should be retracted first while leaving the second and third arms extended. In another example, the sequence indicates a first arm is extended, a second arm remains retracted, a third arm is extended, and a fourth arm is partially extended until an end of the arm contacts an item that is located between the end of the arm and a side member of the conveyor device 118.

The set of instructions, in still other examples, include a timing 1234 for extending or retracting each arm. For example, the timing 1234 can specify that a second arm should be extended one second after the first arm is extended and a third arm should be extended one second after the second arm is extended, etc. In another example, the instructions indicate a first arm should be extended at a first time and a second arm should be retracted at a second time which is two seconds later while a third arm should be retracted three second after the first arm is extended, etc.

In other examples, when the selected item 1220 is detected entering the scan location, the analysis component 1202 analyzes updated (new) sensor data with the item data 132 using the item recognition analytics 1212 and/or the location detection analytics 1214 to generate location data and orientation data for each item in the set of remaining items 1222 relative to the plurality of item alignment arms and the item scan location. The item selection component 1204 selects a next item from the set of remaining items. The next selected item in some examples is the item in the set of remaining items that is located closest to the item scan location. The dynamic instruction generator component 1206 then generates a second set of instructions, including a sequence, timing, a degree of extension and/or a degree of retraction for each telescoping arm to unblock the second selected item so the second selected item is free to move along on the conveyor belt to the scan location. The second set of instructions activate extension and/or retraction of the telescoping arms to stop any un-selected (remaining) items on the conveyor belt from entering the scan location at the same time as the selected item.

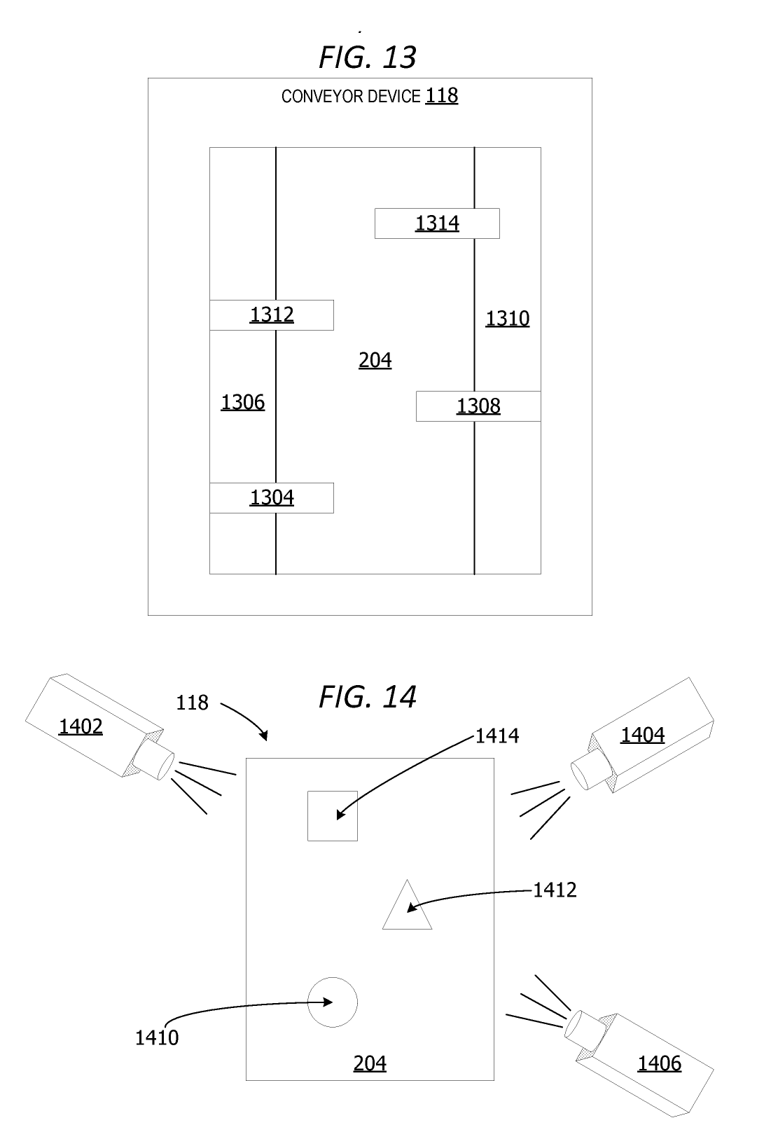

FIG. 13 is an exemplary block diagram illustrating a top view of a conveyor device 118 with a set of partially extended telescoping arms. The conveyor belt 204 includes a first telescoping arm 1304 associated with a first side member 1306 and a second telescoping arm 1308 associated with a second side member 1310. The second side member 1310 is located opposite to the first side member 1306. There are no items shown on the conveyor belt 204 in this non-limiting example.

In some examples, the first side member 1306 includes the telescoping arm 1304 and a telescoping arm 1312. In these examples, the second side member 1310 includes the telescoping arm 1308 and another telescoping arm 1314. The arms 1304, 1308, 1312 and 1314 are partially extended in this example.

FIG. 14 is an exemplary block diagram illustrating a top view of a conveyor device 118 including a set of sensor devices. The set of sensor devices in this non-limiting example includes a first camera 1402, a second camera 1404 and a third camera 1406 generating sensor data associated with a set of items on a conveyor belt 204. However, the examples are not limited to three sensor devices. In other examples, the set of sensor devices include a single camera, two cameras, as well as four or more cameras.

The set of sensor devices generate image data of the items in the set of items. In this non-limiting example, the set of items includes an item 1410, an item 1412 and an item 1414.

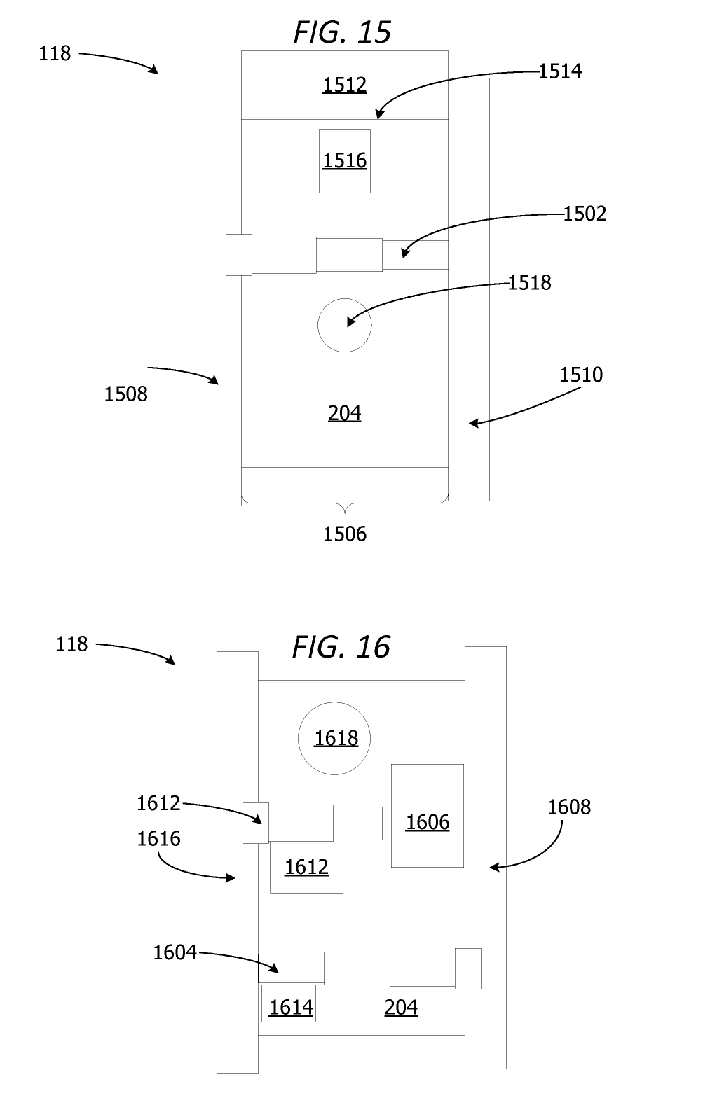

FIG. 15 is an exemplary block diagram illustrating top view of a conveyor device 118 including a single extended telescoping arm 1502 fully extended across an entire width 1506 of a conveyor belt 204. The arm 1502 is attached to a first side member 1508 and extends across to a second side member 1510. As the conveyor belt 204 moves towards a scan location 1512 at an end 1514 of the conveyor belt, the conveyor belt 204 carries an unblocked selected item 1516 towards the scan location. However, the arm 1502 blocks the un-selected (remaining) item 1518, preventing the un-selected item from moving towards the scan location. In other words, as the conveyor belt 204 slides under the arm 1502. The arm blocks/stops the item 1518 from moving closer to the scan location.

FIG. 16 is an exemplary block diagram illustrating a top view of a conveyor device 118 including a partially extended arm 1602 and a fully extended arm 1604. The partially extended arm 1602 pushes an item 1606 against a side member 1608, stopping the item 1608 from moving with the conveyor belt 204. The partially extended arm 1602 blocks another item 1612 which is behind the arm 1602. The arm 1614 also blocks another item 1614 which is located behind the arm 1604. In this example, the arm 1610 is attached to the side member 1608 and the arm 1602 is attached to an opposite side member 1616.

The telescoping arms 1602 and 1604 are extended and/or partially extended to block the un-selected (remaining) set of items from proceeding towards the scan location. The telescoping arms are not blocking a selected item 1618. The selected item is permitted to proceed unobstructed/un-blocked towards the scan location. When the selected item 1618 reaches the end of the conveyor belt 204 (scan location), the arm 1602 partially retracts to un-block the item 1606. The item 1606 is then permitted to move unobstructed towards the scan area. In this example, the arm 1602 only partially retracts such that a portion of the arm 1602 continues blocking the un-selected (remaining) item 1612 until the next selected item 1606 reaches the scan location.

After the item 1606 reaches the scan location, the arm 1602 fully retracts to permit the item 1612 to proceed to the scan location. When the item 1612 reaches the scan location, the arm 1604 retracts to permit the item 1614 to proceed to the scan location. In this manner, the arms extend and retract in a sequence which permits one item at a time to enter the scan location.

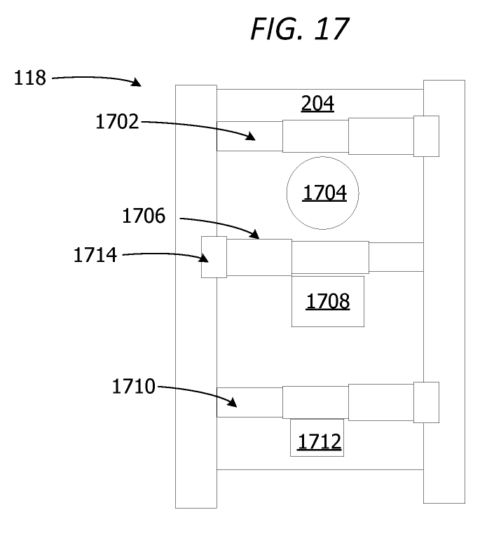

FIG. 17 is an exemplary block diagram illustrating a top view of a conveyor device 118 including three extended telescoping arms. In this example, a first extended arm 1702 blocks an item 1704, a second extended arm 1706 blocks a second item 1708 and a third extended arm 1710 blocks a third item 1712 as it moves down the conveyor belt 204.

Each telescoping arm retracts partially or completely into an arm housing when not needed to block an item. In this example, the arm 1706 is configured to retract into the arm housing 1714.

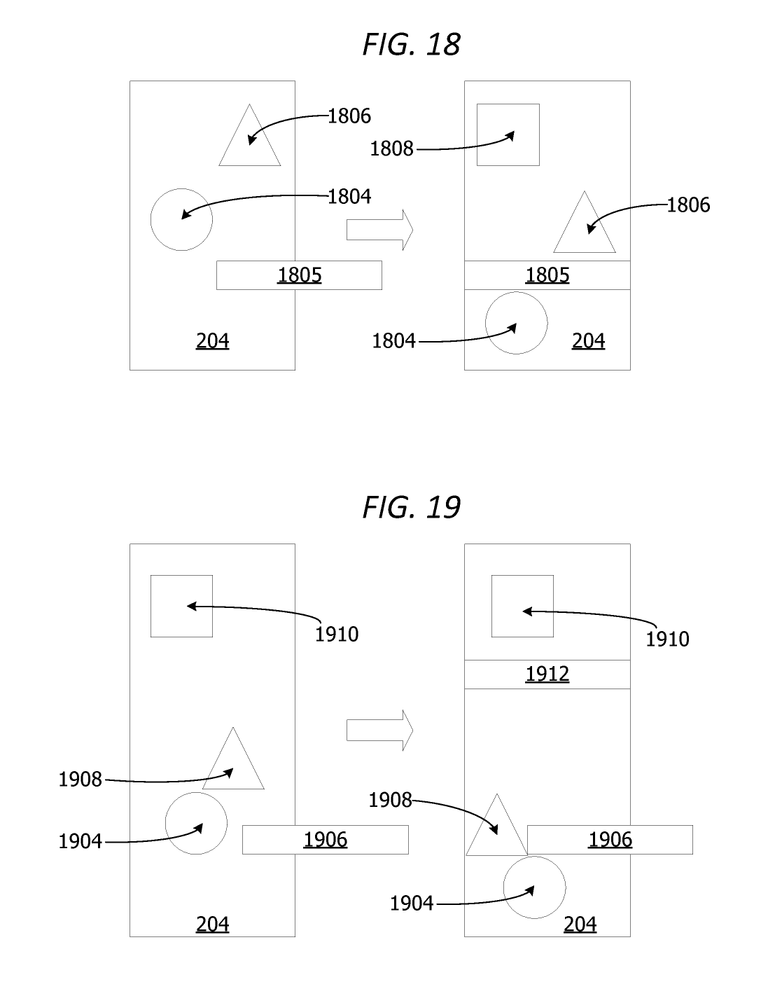

FIG. 18 is an exemplary block diagram illustrating extension of an item alignment arm as items move down a conveyor belt 204. As each item is placed on the conveyor belt 204, an image processor detects and tracks the item. The item 1804 closes to the end (scan location) is selected. As the items move down the conveyor belt 204, the arms on both sides extend to block all un-selected items. In this example, an arm 1805 extends across the conveyor belt 204 to block item 1806 and item 1808 from proceeding down the conveyor belt.

In some examples, when the item 1804 reaches the scan location or some other predetermined point (threshold distance) beyond the item alignment arm 1805, the arm 1805 partially retracts to permit the next selected item to proceed beyond the arm 1805. In this example, item 1808 is closest to an end of the arm 1805. Therefore, the item 1808 is the next selected item. The arm 1805 partially retracts until the item 1808 is freed to proceed past the barrier formed by the arm 1805. Once the item 1808 reaches the item scan location of the predetermined point, the arm 1805 retracts again until the item 1806 is un-blocked.

FIG. 19 is an exemplary block diagram illustrating extension of item alignment arms associated with a conveyor device 1900. The arm 1906 is an item alignment arm. The item alignment arm 1906 can be a single un-segmented arm or a telescoping, segmented arm.

In this example, as a selected item 1904 moves towards the end of the conveyor belt 204, an arm 1906 partially extends until it contacts item 1908. The arm 1906 continues extending to push the un-selected item 1908 all the way to the side of the conveyor belt 204 while making sure no item falls off the edge. The arm 1906 presses the item 1908 against the side member to hold it in place.

Another arm 1912, extends to block item 1910 in this example. Once item 1904 passes a predetermined point within a user-selected range of the scan location, the arm 1906 partially retracts to unblock the item 1908. As the item 1908 reaches the predetermined point, the arm 1912 retracts to unblock the item 1910. In this manner, each item passes one-by-one into the scan area.

In another example, the arm 1906 partially extends to block the item 1908 for a predetermined time-period which provides sufficient separation distance between the item 1904 and the item 1908. When the item 1904 reaches the scan location or the predetermined time-period after item 1904 passes the arm 1906 expires, the arm 1906 partially retracts to unblock item 1908. Once item 1908 is clear, the arm 1906 then extends fully across the conveyor belt 204 to block the item 1910 from moving past the arm 1906 until the second item 1908 either reaches the scan location or the predetermined time-period after unblocking item 1908 expires. In this non-limiting example, the arm 1912 remains retracted and only arm 1906 extends and retracts to sort/align the items moving down the conveyor belt. In other words, the item alignment arms retract and extend in a given sequence and/or timing to alternatively block and un-block items as they flow down a moving conveyor belt to prevent two items from entering the scan location at the same time.

The item alignment arms alternatively retract and extend to slow the progress of a portion of the items moving down the conveyor belt to prevent one item from entering the scan location too soon before a previous item has sufficient time to be scanned in the scan location. In other words, even if items are placed on the conveyor belt in single file (one-by-one), the item alignment arms can extend to slow the progress of one or more items to ensure the first item entering the scan location has sufficient time to be scanned before the next item enters the scan location.

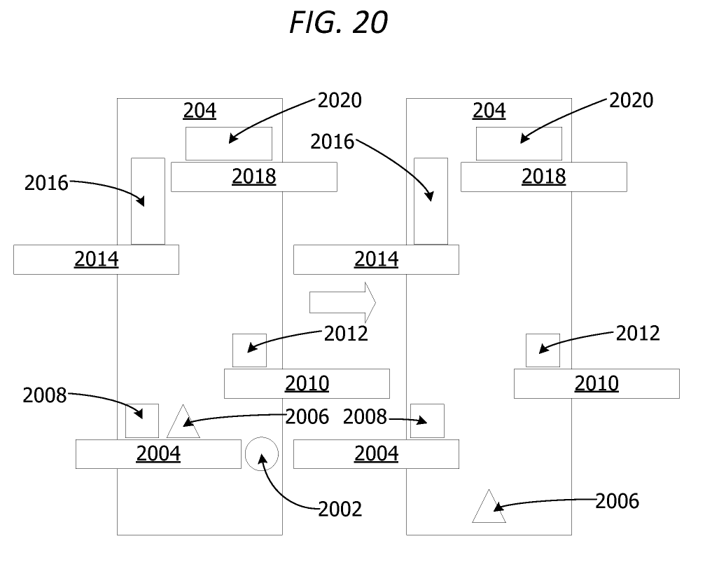

FIG. 20 is an exemplary block diagram illustrating partial extension of a plurality of arms to stop a set of remaining items on a moving conveyor belt 204. The conveyor belt 204 in this example includes four arms on the sides of the conveyor belt to ensure all un-selected items are blocked.

As a selected item 2002 passes a first arm 2004 closes to a scan area, the arm 2004 partially extends to block un-selected item 2006 and un-selected item 2008 while permitting the selected item 2002 to pass un-obstructed. An arm 2010 extends to block an item 2012. Another arm 2014 partially extends to block an item 2016. Yet another arm partially extends to block an un-selected item 2020. Thus, the set of arms partially extend across the conveyor belt to stop the set of remaining items, including items 2006, 2008, 2012, 2016 and 2020.

The arm 2004, arm 2010 and arm 2014 are item alignment arms. The item alignment arms can be a single un-segmented arm or a telescoping, segmented arm.

The arms in this non-limiting example only extend across the conveyor belt as far as necessary to block the un-selected items. For example, the arm 2014 blocks item 2016 by extending only one-fourth of the way across the conveyor belt. Likewise, the arm 2004 extends two-thirds of the way across the conveyor belt width to block items 2006 and 2008. The arm 2020 extends half-way across the conveyor belt width to block item 2020. Thus, the arms do not extend across the entire width of the conveyor belt if it is not necessary to block one or more items.

When the selected item 2002 reaches the scan location or reaches a predetermined point on the conveyor belt within proximity to the scan location, the arm 2004 partially retracts to un-block the next selected item 2006. Item 2006 is the next selected item because item 2006 is closest to the end of the conveyor belt associated with the scan location and farthest from a source location where the items were first placed on the conveyor belt 204. The arm 2010, arm 2014 and arm 2018 do not move. When the item 2006 reaches the scan location and/or the predetermined point, the arm 2004 fully retracts to unblock the next selected item 2008. The item 2008 is the next selected item because it is the next closest item to the scan location.

FIG. 21 is an exemplary flow chart illustrating operation of the computing device to transmit real-time instructions to an arm controller device. The process shown in FIG. 21 can be performed by an item alignment controller, executing on a computing device, such as the computing device 102 in FIG. 1.

The process begins by obtaining sensor data from sensor devices associated with items on a moving conveyor belt at 2102. The sensor data can be data generated by one or more sensor devices, such as, but not limited to, the sensor data 128 in FIG. 1. An analysis component analyzes the sensor data using item data and location detection analytics to identify a location of each item at 2104. The analysis is a component for analyzing data to locate items on a conveyor belt, such as, but not limited to, the analysis component 1202 in FIG. 12. An item selection component determines whether an item is selected at 2106 based on the location data. The item selection component is a component that utilizes location data and/or orientation data to select an item closes to an item scan area and/or farthest from a source location of the conveyor belt, such as, but not limited to, the item selection component 1204 in FIG. 12. A dynamic instruction generator component generates a set of instructions, including a degree of extension, for a set of one or more telescoping arms to stop remaining items while allowing selected items to pass at 2108. The dynamic instruction generator component is a component that utilizes real-time location data for items on a moving conveyor belt to generate instructions for extending and/or retracting one or more telescoping arms to stop un-selected items from moving into the scan area, such as, but not limited to, the dynamic instruction generator component 1206 in FIG. 12. The item alignment controller transmits the instructions to an arm controller device at 2110. The item alignment controller is a controller component, such as, but not limited to, the item alignment controller 134 in FIG. 1. The arm controller device is a device such as, but not limited to, the arm controller device 116 in FIG. 1. The instructions can be sent via a communications interface component, such as, but not limited to, the communications interface device 114 in FIG. 1. The process terminates thereafter.

While the operations illustrated in FIG. 21 are performed by a computing device, aspects of the disclosure contemplate performance of the operations by other entities. For example, a cloud service can perform one or more of the operations.

FIG. 22 is an exemplary flow chart illustrating operation of the computing device to activate extension of a set of arms to stop a set of remaining items from moving down a conveyor belt. The process shown in FIG. 22 can be performed by an item alignment controller, executing on a computing device, such as the computing device 102 in FIG. 1.

The process begins by selecting an item on a conveyor belt that is closest to a scan location at 2202. The item alignment controller determines if there are one or more remaining items behind the selected item at 2204. If no, the process terminates thereafter.

If there is at least one remaining item on the conveyor belt besides the selected item, the item alignment controller identifies a location of each of the remaining items at 2206. The location is determined based on an analysis of sensor data, such as the sensor data 128 in FIG. 1. The item alignment controller identifies a set of one or more telescoping arms between the selected item and the remaining items at 2208. An arm controller device activates the set of telescoping arms at 2210. The item alignment controller determines if the selected item has reached the scan location at 2212. If yes, the item alignment controller determines if a next item remains on the conveyor belt at 2214. If yes, the process returns to 2202 and iteratively executes operations 2202 through 2214 until no items remain on the conveyor belt. The process terminates thereafter.

While the operations illustrated in FIG. 22 are performed by a computing device, aspects of the disclosure contemplate performance of the operations by other entities. For example, a cloud service can perform one or more of the operations.

FIG. 23 is an exemplary flow chart illustrating operation of the computing device to generate instructions for retracting a set of arms to permit a selected item to move to a scan area. The process shown in FIG. 23 can be performed by an item alignment controller, executing on a computing device, such as the computing device 102 in FIG. 1.

The process begins by identifying a next selected item in a set of remaining items on a conveyor belt at 2302. The item alignment controller determines if the next selected item is blocked by one or more telescoping arms at 2304. If no, the process terminates thereafter.

If the next selected item is blocked at 2304, the item alignment controller identifies the one or more arms blocking the selected item at 2306. The item alignment controller generates instructions to partially retract the one or more identified arms to permit the selected item to pass while blocking unselected items 2308. The instructions include instructions to control one or more item alignment arms, such as, but not limited to, the arm control instructions 122 in FIG. 1. The item alignment controller sends instructions to an arm controller device at 2310. The process terminates thereafter.

While the operations illustrated in FIG. 23 are performed by a computing device, aspects of the disclosure contemplate performance of the operations by other entities. For example, a cloud service can perform one or more of the operations.

### Additional Examples

In some examples, the system provides an alignment device, including mechanical arms, for automating a checkout process. The mechanical arms extend and retract as items move down a conveyor belt to stop/block one or more items from proceeding down the conveyor belt to an item scanning area until a previous item is scanned. This ensures single-file flow of items down the conveyor belt such that only a single item passes through a scanning area at a time. The mechanical arms work in concert with optical sensors to differentiate between items and separate the items for scanning. The alignment device prevents double scanning of a single item. The alignment device also ensures each item is scanned when there are multiple items on the conveyor belt. In this manner, the system aligns items on a conveyor belt for each of scanning while reducing processing time during item checkout.

The system in other examples aligns items on a conveyer belt to facilitate efficient scanning and reduce processing time of the item. The system scans individual items one at a time via optical sensors and sensors associated with mechanical arms which work in conjunction for differentiating items and physically separating a selected item from multiple items respectively. The optical sensors are used to differentiate among multiple items. The mechanical arms are extended to stop/block movements of items on the conveyor to allow a single item to enter a scan location for scanning. The system identifies alignment parameters for an individual item to facilitate automated single scan. The system prevents double scanning of an item along the conveyor and ensures multiple scans for multiple items respectively.

The system in other examples includes optical sensors and mechanical arms which work in conjunction for differentiating items and physically separating a selected (first) item from multiple items respectively. The optical sensors are used to differentiate/identify a location of each item on the conveyor belt. The mechanical arms are extended to stop/block movements of items on the conveyor belt to allow a single item to pass through a blocking area into a scanning area for scanning. The system identifies alignment parameters for an individual item to facilitate automated single scan. The system prevents double scanning of an item along the conveyor and ensures multiple scans for multiple items respectively.

In an example scenario, a conveyor belt has multiple sensors that detect the location of each item on a conveyor belt relative to other items on the conveyor belt. For example, the location can indicate one item is in front of a first item and side-by-side with a second item. The system identifies the location of items relative to conveyor belt to determine when to trigger mechanical arms to extend/retract. This allows the first object to pass solo down the conveyor belt before allowing the second identified object to move down the conveyor belt. Using location information to determine position of items in terms of which item is first in line and next after first enables real-time item alignment.

The sensor data is analyzed in some examples using image processing to detect items, differentiate between items, and identify the location of each item on conveyor belt. The location data can include a distance between items, a distance between an item and the scan location, and/or a distance between an item and item alignment arms. The sensor data can be further analyzed to identify the closest item to a target end of conveyor belt.

Could have additional pressure sensors at end of mechanical arm, potentially would touch an item to apply item-appropriate pressure to push an item through. If multiple items are being blocked by same arm and are next to each other (side-by-side), the system selects an item closest to the end of the arm. In this manner, when the arm begins to retract, the selected item is the first item to become un-blocked. The arm can partially retract allow that item on the end to pass while blocking other items by the un-retracted portion of the arm.

In another example, if items are right behind each other, the item alignment arm retracts to allow one selected item to move forward. As soon as the selected item is halfway through the mechanical arm barrier, the arm pushes the selected item to the side of the conveyor belt to then block the immediately adjacent item from moving through barrier as well.

The analysis component in other examples analyzes scan data which is constantly being gathered and transmitted to the analysis component in real-time to identify item dimension and orientation of items on the conveyor belt relative to the conveyor belt and/or the item alignment arms. The system tracks each items's progress down the conveyor belt and determines when an item is halfway through a barrier created by an item alignment arm, for example, based on the dimension info identified.

When an item is blocked by an item alignment arm, the item is stationary (not moving). When an item is un-blocked, the item is moving at the same rate of speed as the conveyor belt. At any point in time, two scanned images of items on the conveyor belt processed against each permits the system to determine where an item to track the item in real-time. The system analyzes the most recent images and identifies different items and bounces those items against items identified in previous images. The system determines if the number of items and location of the items are within the expected incremental change of position based on rate of speed of conveyor belt. If an item is added to the conveyor belt, then it is identified as new item when compared to previous image. The system can include a temporary cache to store current images, previous images, tags/identifiers of items, and/or identified/dimensionality.

An item alignment arm in some examples includes sensor devices embedded within both sides of the arm, as well as the end of the arm. The sensors detect items in contact with either side or end of the arm. Pressure sensors on the arm can generate pressure sensor data indicating whether too much pressure is being applied to an arm. This data can be used to issue an alert/warning of potential damage to the arm and/or trigger automatic stoppage of the conveyor belt or automatic retraction of the item alignment arm back into the arm housing. This prevents damage to the arms.

The direction of movement of the item alignment arms is ninety degrees to the arms. The arms do not push the items around in some examples unless there is a backlog of items getting pushed up against one or more arms.

In other examples, a gap between a bottom surface of an item alignment arm and a top surface of a conveyor belt is minimized to ensure the arm is flush against the conveyor belt as closely as possible. This prevents small items from passing underneath the item alignment arms.

The arms can be composed of metal, plastic, glass, or any other suitable material. In some examples, the item alignment arms are composed of a combination of metal and plastic.

The arms in other examples are hollow, permitting one section/segment of the arm to collapse/nest within the hollow portion of another section/segment of the arm. An item alignment arm can include any number of sensors. In some examples the arm includes two segments. In other examples, the arm is three segments. In still other examples, the arm is composed of four or more segments.

In some examples, if an item is placed on top of an item alignment arm or if an item pressing against an item alignment arm is too large/heavy, the system outputs an alert to a user via a user interface device, such as, but not limited to the user interface component 110 in FIG. 1. The alert can include an identification of the item alignment arm experiencing the problem and/or an instruction for the user to check the arm and/or correct the problem. In other examples, the system automatically stops the conveyor belt from moving if too much pressure is being exerted on any portion of an item alignment arm. This prevents damage to the arms.

The dimensions of the conveyor belt and housing instructs the number of segments and size of segments within each arm. Increasing the number of segments within an arm increases the arm's flexibility and improves the degree of accuracy associated with partial extension to stop items while reducing the size of the arm housing. However, as the number of segments increases, the strength of the arm decreases. If the arm has only a few segments, such as two or three segments, the size of the arm housing capable of accommodating the arm is also larger.

The range of thickness of an item alignment arm in some examples is between one and two inches thick. In still other examples, the thickness of the arm is dictated by the size/weight of the items on the conveyor belt. If the items are very small/light (paper towels, pencils, bread, socks), the arms can have a smaller thickness. If the items are very large/heavy (tools, machinery, appliances), the arms can be much thicker (three inches thick or more).

An item alignment arm in some examples is one inch in height. In other examples, if the items on the conveyor belt are very large/heavy, the arms are one-and-a-half inches or more in height. Likewise, in other non-limiting examples, if the items on the conveyor belt are very small, the arms are three-fourths of an inch in height, a half inch in height or less.

Alternatively, or in addition to the other examples described herein, examples include any combination of the following:
a first telescoping arm attached to the first side member; and a second telescoping arm attached to the first side member a predetermined distance from the first telescoping arm;
wherein the second set of telescoping arms further comprises a third telescoping arm attached to the second side member; and a fourth telescoping arm attached to the second side member the predetermined distance from the third telescoping arm;
the item alignment controller analyzes the sensor data and item data using item recognition analytics and location detection analytics to generate location data and orientation data for each item in the set of remaining items relative to the plurality of item alignment arms and the item scan location;
the item alignment controller identifies a second selected item for scanning and a second set of remaining items from the plurality of items based on the location and orientation data on condition the first selected item is detected in the item scan location;
the item alignment controller generates a second set of instructions, including a sequence, timing and degree of retraction for each telescoping arm in the plurality of item alignment arms to partially retract to permit the second selected item to move unobstructed along the conveyor belt to the item scan area;
the arm controller device associated with the plurality of item alignment arms that dynamically activates at least partial retraction of at least one telescoping arm in the plurality of item alignment arms to unblock the second selected item while stopping the second set of remaining items from proceeding down the conveyor belt in accordance with the second set of instructions;
wherein the plurality of sensor devices further comprises a set of image capture devices generating image data associated with the plurality of items, and further comprising the item alignment controller implemented on the at least one processor, analyzes the sensor data and the item data using image recognition analytics to identify each item on the conveyor belt;
wherein the plurality of sensor devices further comprises a set of pressure sensors associated with the plurality of item alignment arms generating pressure data, wherein the pressure data is analyzed to determine the location of at least one item in the set of remaining items on the conveyor belt;
a first telescoping arm in the plurality of item alignment arms, wherein the arm controller device fully extends the first telescoping arm across an entire width of the conveyor belt in accordance with the set of instructions to block at least one item located between the first telescoping arm and the first end of the conveyor belt;
a first telescoping arm in the plurality of item alignment arms attached to the first side member, wherein the arm controller device fully extends the first telescoping arm across an entire width of the conveyor belt in accordance with the set of instructions to block at least one item located between the first telescoping arm and a second telescoping arm attached to the second side member;
a first telescoping arm in the plurality of item alignment arms, wherein the arm controller device partially extends the first telescoping arm across a portion of the width of the conveyor belt in accordance with the set of instructions to block at least one item located between an end of the first telescoping arm and the first side member of the conveyor device;
extending, by the arm controller device, a first arm in the plurality of item alignment arms at least partially across the width of the conveyor belt on condition the set of remaining items comprises at least one item;
extending, by an arm controller device, a subset of telescoping arms in the plurality of item alignment arms at least partially across the width of the conveyor belt on condition the set of remaining items comprises at least two items, the subset of telescoping arms comprising a first arm and a second arm;
extending, by an arm controller device, a subset of telescoping arms in the plurality of item alignment arms at least partially across the width of the conveyor belt on condition the set of remaining items comprises at least three items, the subset of telescoping arms comprising a first arm, a second arm and a third arm;
extending, by an arm controller device, a subset of telescoping arms in the plurality of item alignment arms at least partially across the width of the conveyor belt on condition the set of remaining items comprises at least four items, the subset of telescoping arms comprising first arm, a second arm, a third arm and a fourth arm;
fully extending, by an arm controller device, a first telescoping arm across an entire width of the conveyor belt to block at least one item located between the first telescoping arm and the first end of the conveyor belt;
fully extending, by an arm controller device, a first telescoping arm across an entire width of the conveyor belt to block at least one item located between the first telescoping arm and a second telescoping arm attached to the second side member;
partially extending, by an arm controller device, a first telescoping arm in the plurality of item alignment arms across a portion of the width of the conveyor belt to block at least one item located between an end of the first telescoping arm and the first side member of the conveyor device;
the item alignment controller analyzes sensor data and item data using item recognition and location detection analytics to generate location and orientation data for each item in the plurality of items relative to the plurality of item alignment arms and an item scan location associated with a second end of the conveyor belt;
the item alignment controller identifies a first selected item for scanning and a set of remaining items from the plurality of items based on the location and orientation data;
the item alignment controller generates a set of instructions, including a sequence, timing and degree of extension for each telescoping arm in the plurality of item alignment arms to stop the set of remaining items while permitting the first selected item to move unobstructed along the conveyor belt to the item scan area;
the item alignment controller transmits the set of instructions to the arm controller device in real-time;
the item alignment controller analyzes the sensor data and item data using item recognition analytics and location detection analytics to generate location and orientation data for each item in the set of remaining items relative to the plurality of item alignment arms and the item scan location;
the item alignment controller identifies a second selected item for scanning and a second set of remaining items from the plurality of items based on the location data and orientation data on condition the first selected item is detected in the item scan location;
the item alignment controller generates a second set of instructions, including a sequence, timing and a degree of extension for each telescoping arm in the plurality of item alignment arms to stop the second set of remaining items while permitting the second selected item to move unobstructed along the conveyor belt to the item scan area; and
the arm controller device associated with the plurality of item alignment arms that dynamically activates at least partial retraction of at least one telescoping arm in the plurality of item alignment arms to unblock the second selected item while stopping the second set of remaining items from proceeding down the conveyor belt in accordance with the second set of instructions.

At least a portion of the functionality of the various elements in FIG. 1, FIG. 2, FIG. 3, FIG. 4, FIG. 5, FIG. 6, FIG. 7, FIG. 8, FIG. 9, FIG. 10, FIG. 11, FIG. 12, FIG. 13, FIG. 14, FIG. 15, FIG. 16, FIG. 17, FIG. 18, FIG. 19, and FIG. 20 can be performed by other elements in FIG. 1, FIG. 2, FIG. 3, FIG. 4, FIG. 5, FIG. 6, FIG. 7, FIG. 8, FIG. 9, FIG. 10, FIG. 11, FIG. 12, FIG. 13, FIG. 14, FIG. 15, FIG. 16, FIG. 17, FIG. 18, FIG. 19, and FIG. 20, or an entity (e.g., processor 106, web service, server, application program, computing device, etc.) not shown in FIG. FIG. 1, FIG. 2, FIG. 3, FIG. 4, FIG. 5, FIG. 6, FIG. 7, FIG. 8, FIG. 9, FIG. 10, FIG. 11, FIG. 12, FIG. 13, FIG. 14, FIG. 15, FIG. 16, FIG. 17, FIG. 18, FIG. 19, and FIG. 20.

In some examples, the operations illustrated in FIG. 21, FIG. 22, and/or FIG. 23 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other general purpose or special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for aligning items on a moving conveyor belt in real-time without human intervention. For example, the elements illustrated in FIG. 1, FIG. 2, FIG. 3, FIG. 4, FIG. 5, FIG. 6, FIG. 7, FIG. 8, FIG. 9, FIG. 10, FIG. 11, FIG. 12, FIG. 13, FIG. 14, FIG. 15, FIG. 16, FIG. 17, FIG. 18, FIG. 19, and FIG. 20, such as when encoded to perform the operations illustrated in FIG. 21, FIG. 22 and FIG. 23, constitute exemplary means for obtaining sensor data from one or more sensor devices associated with a plurality of items placed on a moving conveyor belt at a source location associated with a first end of the conveyor belt via a network; exemplary means for analyzing the sensor data and item data associated with the plurality of items using item recognition analytics and location detection analytics to generate location data and orientation data for each item in the plurality of items; exemplary means for identifying a first selected item and a set of remaining items from the plurality of items based on the location data and orientation data; exemplary means for generating a set of instructions, including a degree of extension, for each telescoping arm in the plurality of item alignment arms to stop the set of remaining items from proceeding down the conveyor belt to an item scan area at a second end of the conveyor belt while permitting the first selected item to move unobstructed toward the item scan area; and exemplary means for dynamically activating at least partial extension of at least one telescoping arm in the plurality of item alignment arms across at least a portion of the width of the conveyor belt in accordance with the set of instructions.

Other non-limiting examples provide one or more computer storage devices having a first computer-executable instructions stored thereon for providing arm control instructions for aligning items on a conveyor device in real-time. When executed by a computer, the computer performs operations including obtaining sensor data from one or more sensor devices associated with a plurality of items placed on a moving conveyor belt at a source location associated with a first end of the conveyor belt via a network; analyzing the sensor data and item data associated with the plurality of items using item recognition analytics and location detection analytics to generate location data and orientation data for each item in the plurality of items; identifying a first selected item and a set of remaining items from the plurality of items based on the location data and orientation data; generating a set of instructions, including a degree of extension, for each telescoping arm in the plurality of item alignment arms to stop the set of remaining items from proceeding down the conveyor belt to an item scan area at a second end of the conveyor belt while permitting the first selected item to move unobstructed toward the item scan area; and dynamically activating extension of at least one telescoping arm in the plurality of item alignment arms across at least a portion of the width of the conveyor belt in accordance with the set of instructions.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there can be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for dynamic alignment of items on a conveyor device, the system comprising:
a conveyor belt comprising a set of side members running horizontally along each longitudinal side of the conveyor belt;
a plurality of item alignment arms associated with the set of side members, the plurality of item alignment arms comprising a first set of telescoping arms attached to a first side member in the set of side members parallel to the conveyor belt and a second set of telescoping arms attached to a second side member in the set of side members opposite to the first side member, each arm in the plurality of item alignment arms having a fully extended length equal to a width of the conveyor belt;
a plurality of sensor devices generating sensor data associated with a plurality of items placed on the conveyor belt at a source location associated with a first end of the conveyor belt;
a computing device comprising a processor, a memory communicatively coupled to the memory, and an item alignment controller implemented on at least one processor, that:
analyzes the sensor data and item data using item recognition analytics and location detection analytics to generate location and orientation data for each item in the plurality of items relative to the plurality of item alignment arms and an item scan location associated with a second end of the conveyor belt;
identifies a selected item for scanning and a set of remaining items from the plurality of items based on the location and orientation data; and
generates a set of instructions, including a degree of extension for each telescoping arm in the plurality of item alignment arms to stop the set of remaining items while permitting the selected item to move unobstructed along the conveyor belt to an item scan area; and
an arm controller device associated with the plurality of item alignment arms dynamically activates at least partial extension of at least one telescoping arm in the plurality of item alignment arms across the width of the conveyor belt in accordance with the set of instructions.

2. The system of claim 1, wherein the first set of telescoping arms further comprises:
a first telescoping arm attached to the first side member; and
a second telescoping arm attached to the first side member a predetermined distance from the first telescoping arm.

3. The system of claim 2, wherein the second set of telescoping arms further comprises:
a third telescoping arm attached to the second side member; and
a fourth telescoping arm attached to the second side member the predetermined distance from the third telescoping arm.

4. The system of claim 1, wherein the set of instructions is a first set of instructions and further comprising:
the item alignment controller implemented on the at least one processor, that:
analyzes the sensor data and the item data using the item recognition analytics and the location detection analytics to generate location data and orientation data for each item in the set of remaining items relative to the plurality of item alignment arms and the item scan location;
identifies a second selected item for scanning and a second set of remaining items from the plurality of items based on the location and orientation data on condition the first selected item is detected in the item scan location; and
generates a second set of instructions, including a sequence, timing and the degree of retraction for each telescoping arm in the plurality of item alignment arms to partially retract permitting the second selected item to move along the conveyor belt to the item scan area; and
the arm controller device associated with the plurality of item alignment arms that dynamically activates at least partial retraction of the at least one telescoping arm in the plurality of item alignment arms to unblock the second selected item while stopping the second set of remaining items from proceeding down the conveyor belt in accordance with the second set of instructions.

5. The system of claim 1, wherein the plurality of sensor devices further comprises a set of image capture devices generating image data associated with the plurality of items, and further comprising:
the item alignment controller implemented on the at least one processor, analyzes the sensor data and the item data using image recognition analytics to identify each item on the conveyor belt.

6. The system of claim 1, wherein the plurality of sensor devices further comprises:
a set of pressure sensors associated with the plurality of item alignment arms generating pressure data, wherein the pressure data is analyzed to determine a location of at least one item in the set of remaining items on the conveyor belt.

7. The system of claim 1, further comprising:
a first telescoping arm in the plurality of item alignment arms, wherein the arm controller device fully extends the first telescoping arm across the width of the conveyor belt in accordance with the set of instructions to block at least one item located between the first telescoping arm and the first end of the conveyor belt.

8. The system of claim 1, further comprising:
a first telescoping arm attached to the first side member, wherein the arm controller device fully extends the first telescoping arm across the width of the conveyor belt in accordance with the set of instructions to block at least one item located between the first telescoping arm and a second telescoping arm attached to the second side member.

9. The system of claim 1, further comprising:
a first telescoping arm in the plurality of item alignment arms, wherein the arm controller device partially extends the first telescoping arm across a portion of the width of the conveyor belt in accordance with the set of instructions to block at least one item located between an end of the first telescoping arm and the first side member of the conveyor device.

10. A computer-implemented method for dynamically aligning items on a conveyor device, the computer-implemented method comprising:
obtaining, by a communications interface component, sensor data generated by a plurality of sensor devices associated with a plurality of items placed on a conveyor belt at a source location associated with a first end of the conveyor belt via a network;
analyzing, by an analysis component, the sensor data and item data associated with the plurality of items using item recognition analytics and location detection analytics to generate location data and orientation data for each item in the plurality of items;
identifying, by an item selection component, a first selected item and a set of remaining items from the plurality of items based on the location data and orientation data;
generating, by a dynamic instruction generator component, a set of instructions, including a degree of extension, for each telescoping arm in a plurality of item alignment arms to stop the set of remaining items from proceeding down the conveyor belt to an item scan area at a second end of the conveyor belt while permitting the first selected item to move unobstructed toward the item scan area; and
dynamically activating, by an arm controller device, at least partial extension of at least one telescoping arm in the plurality of item alignment arms across at least a portion of a width of the conveyor belt in accordance with the set of instructions.

11. The computer-implemented method of claim 10, further comprising:
extending, by the arm controller device, a first arm in the plurality of item alignment arms at least partially across the width of the conveyor belt on condition the set of remaining items comprises at least one item.

12. The computer-implemented method of claim 10, further comprising:
extending, by the arm controller device, a subset of telescoping arms in the plurality of item alignment arms at least partially across the width of the conveyor belt on condition the set of remaining items comprises at least two items, the subset of telescoping arms comprising a first arm and a second arm.

13. The computer-implemented method of claim 10, further comprising:
extending, by the arm controller device, a subset of telescoping arms in the plurality of item alignment arms at least partially across the width of the conveyor belt on condition the set of remaining items comprises at least three items, the subset of telescoping arms comprising a first arm, a second arm and a third arm.

14. The computer-implemented method of claim 10, further comprising:
extending, by the arm controller device, a subset of telescoping arms in the plurality of item alignment arms at least partially across the width of the conveyor belt on condition the set of remaining items comprises at least four items, the subset of telescoping arms comprising first arm, a second arm, a third arm and a fourth arm.

15. The computer-implemented method of claim 10, further comprising:
fully extending, by the arm controller device, a first arm across the width of the conveyor belt to block at least one item located between the first arm and the first end of the conveyor belt.

16. The computer-implemented method of claim 10, further comprising:
fully extending, by the arm controller device, a first arm across the width of the conveyor belt to block at least one item located between the first arm attached to a first side member of the conveyor device and a second arm attached to a second side member of the conveyor device.

17. The computer-implemented method of claim 10, further comprising:
partially extending, by the arm controller device, a first arm in the plurality of item alignment arms across the portion of the width of the conveyor belt to block at least one item located between an end of the first arm and a first side member of the conveyor device.

18. A conveyor device for aligning items on a conveyor belt, the conveyor device comprising:
the conveyor belt configured to move a plurality of items from a source location associated with a first end of the conveyor belt to an item scan location associated with a second end of the conveyor belt;
a first side member running horizontally along a first longitudinal side of the conveyor belt;
a second side member running horizontally along a second longitudinal side of the conveyor belt opposite to the first longitudinal side;
an arm controller device associated with a plurality of item alignment arms;
the plurality of item alignment arms comprising a first set of telescoping arms associated with the first side member and a second set of telescoping arms associated with the second side member, each arm in the plurality of item alignment arms having a fully extended length equal to a width of the conveyor belt;
the first set of telescoping arms comprising a first arm and a second arm located a first distance away from the first arm;
the second set of telescoping arms comprising a third arm and a fourth arm located a second distance away from the third arm;
a communications interface component receives a set of instructions from an item alignment controller via a network; and
the arm controller device dynamically activates at least partial extension of at least one telescoping arm in the plurality of item alignment arms across the width of the conveyor belt in accordance with the set of instructions to permit a selected item in the plurality of items to move along the conveyor belt towards the item scan location while stopping a set of remaining items in the plurality of items from proceeding down the conveyor belt until the selected item reaches the item scan location.

19. The conveyor device of claim 18, further comprising:
a processor, a memory communicatively coupled to the memory, and the item alignment controller implemented on at least one processor, that:
analyzes sensor data and item data using item recognition analytics and location detection analytics to generate location and orientation data for each item in the plurality of items relative to the plurality of item alignment arms and the item scan location;
identifies a first selected item for scanning and a first set of remaining items from the plurality of items based on the location and orientation data;
generates the set of instructions, including a sequence, timing and a degree of extension for each telescoping arm in the plurality of item alignment arms to stop the set of remaining items while permitting the first selected item to move unobstructed along the conveyor belt to an item scan area; and
transmits the set of instructions to the arm controller device in real-time.

20. The conveyor device of claim 19, wherein the set of instructions is a first set of instructions and further comprising:
the item alignment controller implemented on at least one processor, that:
analyzes the sensor data and the item data using the item recognition analytics and the location detection analytics to generate the location and orientation data for each item in the set of remaining items relative to the plurality of item alignment arms and the item scan location;
identifies a second selected item for scanning and a second set of remaining items from the plurality of items based on location data and orientation data on condition the first selected item is detected in the item scan location; and
generates a second set of instructions, including the sequence, timing and the degree of extension for each telescoping arm in the plurality of item alignment arms to stop the second set of remaining items while permitting the second selected item to move unobstructed along the conveyor belt to the item scan area; and
the arm controller device associated with the plurality of item alignment arms that dynamically activates at least partial retraction of the at least one telescoping arm in the plurality of item alignment arms to unblock the second selected item while stopping the second set of remaining items from proceeding down the conveyor belt in accordance with the second set of instructions.
